(19) United States
(12) Patent Application Publication
(10) Pub. No.: US 2017/0130569 A1
(43) Pub. Date: May 11, 2017

(54) SYSTEM FOR FORMING A HORIZONTAL WELL FOR ENVIRONMENTAL REMEDIATION AND METHOD OF OPERATION

(71) Applicant: Michael Sequino, Miramar Beach, FL (US)

(72) Inventor: Michael Sequino, Miramar Beach, FL (US)

(21) Appl. No.: 14/937,172

(22) Filed: Nov. 10, 2015

(51) Int. Cl. E21B 43/26; E21B 47/024; B09C 1/00; E21B 7/04

(52) U.S. Cl. CPC E21B 43/26; E21B 7/046; E21B 47/024; B09C 1/00; E21B 43/267

(57) ABSTRACT

A system and method of forming a horizontal well for use in environmental remediation is provided. The method includes forming a bore hole to a desired location. A fracturing tool is moved to the end of the bore hole. The fracturing tool is rotated to arrange a nozzle at a desired orientation for directing energy into the soil. The energy directed into the soil generates fractures that improve the efficiency of environmental remediation of the soil.

### BACKGROUND OF THE DISCLOSURE

The subject matter disclosed herein relates to a system for ground soil environmental remediation, and in particular to an environmental remediation system that uses horizontal drilling and fracturing of the soil.

Contaminated subsurface formations may be located under structures such as buildings, storage tanks, roadways, shallow waterways, land farms, and the like. These locations present an especially difficult situation as the contaminated areas are often inaccessible by conventional methods resulting in an expensive problem to correct or impossible.

The most common environmental problem encountered in subsurface formations is contaminated soil and ground water. One method of removing contaminants from subsurface formations is by excavating the contaminated subsurface material. This method of eliminating contaminants from subsurface formations is very, disruptive, expensive and time consuming. Other techniques have been successfully used, such as vertical or horizontally drilled wells. However, the effectiveness of these techniques has sometimes been reduced due to the limited amount of subsurface exposure to the contaminated soil.

Accordingly, while existing environmental remediation systems have been suitable for their intended purposes the need for improvement remains, particularly in providing a system that improves the effectiveness of horizontally drilled wells.

### BRIEF DESCRIPTION OF THE DISCLOSURE

According to one aspect of the disclosure, a method of forming a horizontal well in a contaminated soil environmental remediation system is provided. The method includes drilling a bore hole with a drill head to a desired location. A fracturing device is inserted into the bore hole, the fracturing device including a locating device and a nozzle configured to direct energy using a fracturing media/material, the locating device configured determine a position and at least one rotational orientation of the fracturing device. The fracturing device is moved within the bore hole. A signal is transmitted from the locating device, the signal including the position and at least one rotational orientation. The nozzle is rotated based at least in part on the signal. The fracturing media/material is emitted. A first fracture is generated in the contaminated soil with the emitted fracturing media/material.

According to another aspect of the disclosure a fracturing device is provided. The fracturing device includes at least one nozzle with at least two ports. A packer wedge is coupled to the at least one nozzle. A location device is operably coupled to and aligned with the at least one nozzle, the location device configured to determine a position and at least one orientation of the fracturing device when located in a bore hole, the location device further configured to transmit a sign indicating the position and orientation of the fracturing device to a remote device.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a drilling assembly for an environmental remediation system having a horizontally drilled well;

FIG. 2 is a schematic illustration of a fracturing assembly for use with the horizontal drilling assembly of FIG. 1;

FIG. 3 is a schematic illustration of the drilling assembly of FIG. 1 with a fracturing of the soil performed at a first location;

FIG. 4 is a schematic illustration of the drilling assembly of FIG. 1 with a fracturing of the soil performed at a second location; and

FIG. 5 is a flow diagram of a method of forming a horizontally drilled well for an environmental remediation system.

The detailed description explains embodiments of the disclosure, together with advantages and features, by way of example with reference to the drawings.

### DETAILED DESCRIPTION OF THE DISCLOSURE

Embodiments of the present invention provide advantages in improving the effectiveness and performance of horizontally drilled wells in environmental remediation systems. Embodiments of the present invention provide advantages in allowing the fracturing of contaminated soil around a horizontally drilled well to improve removal of the contaminants from the soil by increasing the soil porosity.

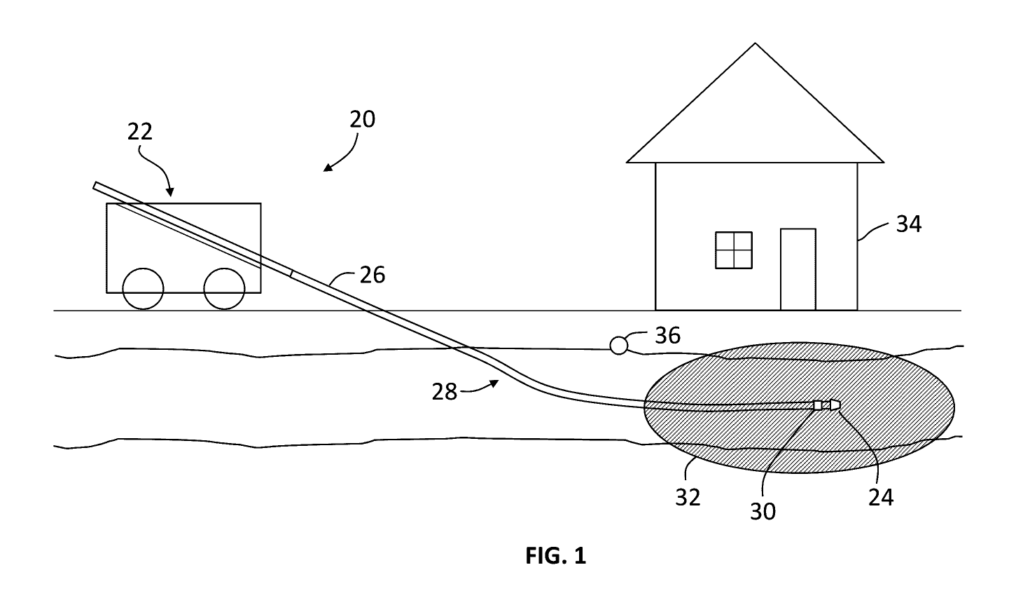

Referring now to FIG. 1 an exemplary drilling system 20 configured to form a horizontal well for use in an environmental remediation system. The system 20 includes a drilling machine 22 that is configured to power and direct a drill head 24 arranged on the end of a tool string 26 to define a bore hole 28. The assembly further includes an electronic locating device 30 inside the drill head 24. The electronic locating device 30 allows the remote location and orientation of the drill head 24. This allows an operator at the drilling machine 22 to direct the drilling head 24 to form the bore hole 28 to a desired location. In the exemplary embodiment, the electronic locating device 30 includes a wireless or wired transmitter, such as the DigiTrak F5 Locating System manufactured by Digital Control Incorporated of Kent, Wash.

The system 20 is configured to allow an operator to selectively turn the drill head to form a bore hole 28 in the desired location. It should be appreciated that the assembly 20 may be used to steer around or under objects (e.g. buildings 34, underground conduits 36, etc.) into the vicinity of contaminated subsurface formation 32. During this process, a cylindrical tunnel or bore hole 28 is formed by the drill head 24. It should be appreciated that subsequent to the formation of the bore hole 28 by the drill head 24, a pipe or conduit may be inserted into the bore hole 28 that may be used to extract contaminants from the soil or ground water as is known in the art.

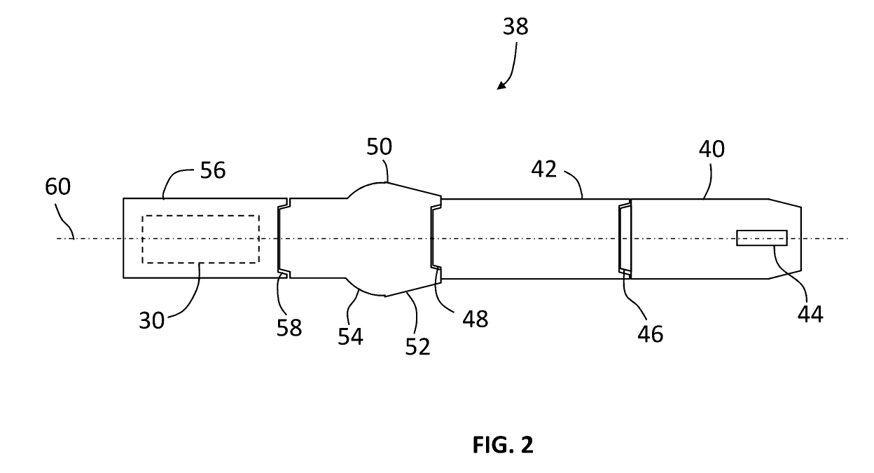

While the process of horizontally forming the bore hole 28 allows the remediation screens to be placed into the contaminated subsurface formation 32, the ability to extract the contaminants is somewhat limited by the amount of surface area that is exposed to the formation and it's properties 32. It has been found that the effectiveness of the remediation may be enhanced by fracturing the soil in areas adjacent the bore hole 28. Turning now to FIG. 2, an exemplary contaminated soil fracturing device 38 is shown. The fracturing device 38 is sized to be received within the bore hole 28. The device includes a nozzle section 40 and a leading segment section 42. The leading segment section 42 is sometimes colloquially referred to as a “stinger.” The nozzle section includes a nozzle 44 that is used to direct energy into the surrounding soil to fracture the soil. The nozzle 44 may be fluidly coupled to a fracturing fluid system that selectively provides high pressure fluid or air to the nozzle. In one embodiment, the nozzle 44 is configured to be removably coupled to the nozzle section 40 to allow the nozzle 44 to be changed depending on the formation and type of fracture that is desired.

The stinger 42 couples to a trailing end 46 of the nozzle section 40. The stinger may be made up of different lengths of drill pipe, such as a 10 foot (3.048 meter), 2.375 inch (60.325 millimeter) pipe for example. The length of the stinger 42 may be changed to adjust for soil conditions. In softer soil, a longer length may be used while in harder soil a shorter length may be used. In one embodiment, the stinger 42 diameter is a “flush” pipe meaning that the tool joints are flush with the tube of the drill pipe.

Coupled to a trailing edge 48 of stinger 42 is a packer wedge 50. As will be discussed in more detail below, the packer wedge 50 is used to isolate the bore hole 28 with the hole created by the stinger 42. This provides advantages in allowing the soil to be fractured without pressure generated during the fracturing event from flowing back up the bore hole 28 toward the drilling machine 22. In one embodiment, the packer wedge includes a conical portion 52 and a hemispherical or semispherical portion 54. It should be appreciated that the packer wedge 50 may have other outer surfaces having different geometric configurations as is known in the art. In one embodiment, the outer surfaces 52, 54 cooperate with a portion of the undrilled bore hole 28 to form a seal.

A navigation section 56 is coupled to a trailing end 58 of the packer wedge 50. The navigation section 56 includes an electronic locating device 30, sometimes colloquially referred to as a “sonde.” As discussed above, the locating device 30 allows the operator to know the location and orientation the locating device 30 when it is within the bore hole 28. In the exemplary embodiment, the locating device 30 transmits a signal to the operator allowing the operator to determine the translational coordinates (x, y, z) and the rotational orientation about an axis 60 that extends through the device 38. In another embodiment, the locating device 30 allows the operator to determine the coordinates to six-degrees of freedom (x, y, z and three angulation orientations).

It should be appreciated that while embodiments herein describe the navigation section 56 being coupled to the packer wedge 50 opposite the stinger 42, this is for exemplary purposes and the claimed invention should not be so limited. In other embodiments, the navigation section 56 may be located between the packer wedge 50 and the stinger 42.

In the exemplary embodiment, the locating device 30 is configured to be aligned with the nozzle 44, such that the operator may determine the position and orientation of the nozzle 44. As will be discussed in more detail below, this provides advantages in allowing the operator to form fractures in the formation 32 at a desired position and in a desired direction to allow an increase in the efficiency of the remediation system.

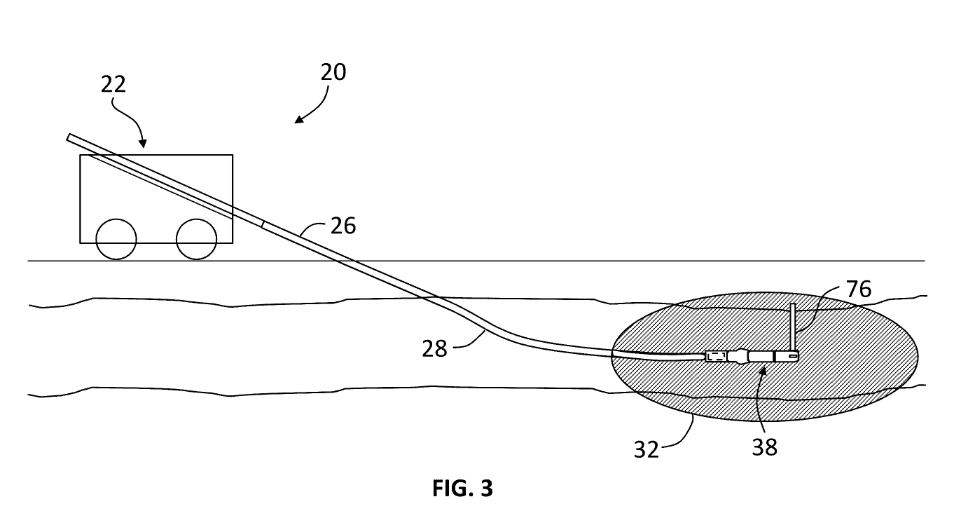

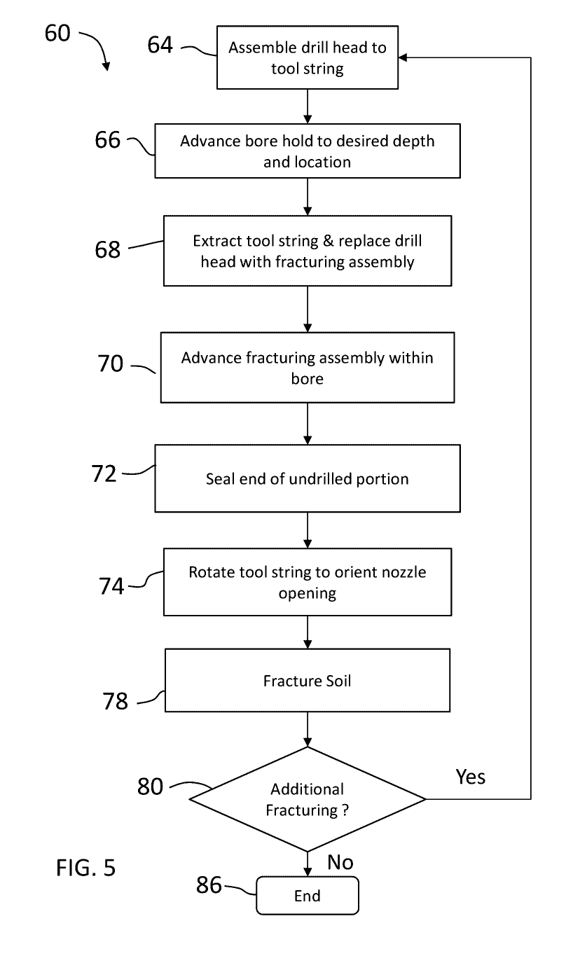

Referring now to FIGS. 3-5, a method 62 of operating the system 20 to define a bore hole 28 within a formation 32 with at least one soil fracture created using the device 38. The method starts in block 64 where the drill head 24 is coupled to a tool string. The method then proceeds in block 66 to define a bore hole 28 using the drill head 24. The direction of the drill head 24 is controlled to position the end of the bore hole 28 in a desired fracture location, such as within or adjacent to the contaminated subsurface formation 32. It should be appreciated that typically the position of the bore hole 28 is at a depth of less than thirty feet from the surface. Once the drill head 24 has reached the desired location for the fracturing event, the drill head 24 is extracted from the bore hole 28 and replaced with the fracturing device 38 in block 68. The method 60 the proceeds in block 70 to advance the fracturing device 38 through the bore hole 28 until the packer wedge 50 engages the end of the bore hole 28 formed by the drill head 24. In other words the packer wedge 50 contacts and seals the end of the bore hole 28 with the stinger 42 and nozzle section 40 extending into the soil beyond the end of the drilled bore hole 28. The end of the drilled portion of bore hole 28 is sealed in block 72.

The operator determines the orientation of the nozzle 44 via a signal from the locating device 30. The operator then rotates the fracturing device 38 in block 74 to orient the nozzle 44 for directing energy in a direction where fracturing is desired. In an embodiment, the system 20 rotates the entire drill string with the fracturing assembly and it's nozzle to the desired orientation. In the exemplary embodiment, the nozzle 44 is fluidly coupled to a fracturing fluid system that provides high pressure fluid, air and a propping agent with possible sand or glass beads or any other substrate that might be required. The directed energy creates a fracture 76 (FIG. 3) in the soil in block 78. It should be appreciated that the direction and amount of fracturing that occurs may be changed depending on the soil conditions of the area and type of contaminant being remediated.

It should be appreciated that while the embodiment described herein refers to the operator determining the position and orientation, this is for exemplary purposes and the claimed invention should not be so limited. In other embodiments, these process steps may be performed automatically by a controller in response to a predetermined environmental remediation plan or in response to soil conditions.

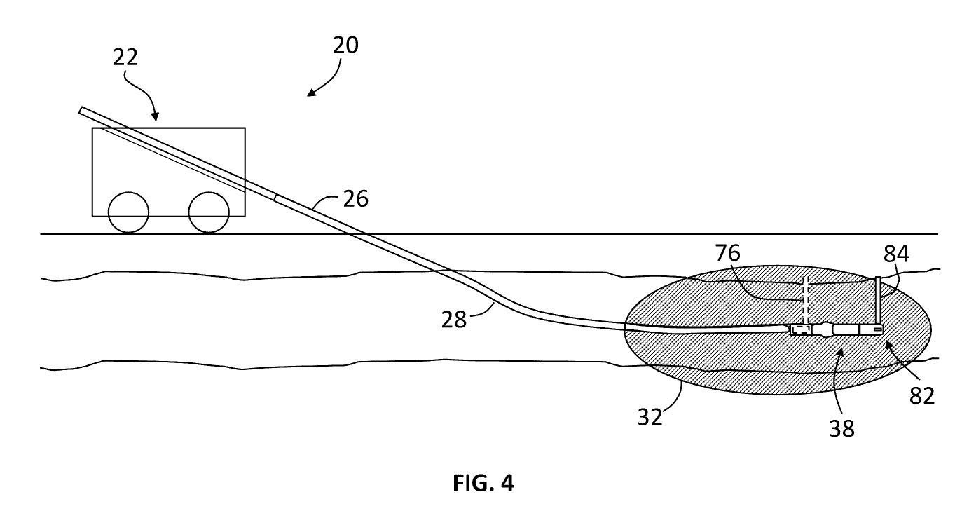

In one embodiment, the nozzle 74 may be used to generate multiple fractures 76 in different directions by sequentially performing the fracturing step and rotating the fracturing device 38 about the axis 60. The method 60 then proceeds to query block 80 where it is determined if additional fracturing locations are desired, the query block 80 returns a positive and the method 60 loops back to block 64. The fracturing device 38 is removed and replaced with the drill head 24 and the bore hole 28 is extended (FIG. 4) to a new desired location 82. Once again the drill head 24 is removed and replaced with the fracturing device 38 as discussed above. When the fracturing device 38 is in the location 82 with the nozzle 44 oriented in the desired direction, one or more additional fractures 84 are generated.

It should be appreciated that this process may be repeated any number of times to generate the desired number of fractures 76, 84. Once all of the desired soil fractures have been generated, the query block 80 returns a negative and the method 60 ends in block 86. The remainder of the remediation system may be installed in the bore hole 28 to form the horizontal well as is known in the art.

The technical effects and benefits of embodiments of the present invention include increasing the efficiency of a remediation of contaminated soil. Embodiments of the invention provide advantages in the installation of remediation systems in congested areas through the use of horizontally drilled wells.

The term “about” is intended to include the degree of error associated with measurement of the particular quantity based upon the equipment available at the time of filing the application. For example, “about” can include a range of +/−5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method of forming a horizontal well in a contaminated soil environmental remediation system, the method comprising:
drilling a bore hole with a drill head to a desired location;
inserting a fracturing device into the bore hole, the fracturing device including a locating device and a nozzle configured to direct energy using a fracturing material, the locating device configured determine a position and at least one rotational orientation of the fracturing device;
moving the fracturing device within the bore hole;
transmitting a signal from the locating device, the signal including the position and at least one rotational orientation;
rotating the nozzle based at least in part on the signal;
emitting the fracturing material; and
generating a first fracture in the contaminated soil with the emitted fracturing material.

2. The method of claim 1 wherein the fracturing device includes a packer wedge.

3. The method of claim 2 further comprising:
positioning the packer wedge at an end of the bore hole; and
forming a seal between the packer wedge and the bore hole.

4. The method of claim 3 further comprising moving the nozzle into the contaminated soil beyond the end of the bore hole.

5. The method of claim 4 further comprising rotating the nozzle to a second orientation and generating a second fracture in the contaminated soil.

6. The method of claim 5 further comprising:
removing the fracturing device from the bore hole;
inserting the drill head into the bore hole; and
extending the bore hole with the drill head to a location beyond the first fracture.

7. The method of claim 6 further comprising:
removing the drill head from the bore hole after extending the bore hole to a location beyond the first fracture;
inserting the fracturing device into the bore hole; and
moving the fracturing device to the location in the bore hole beyond the location of the first fracture.

8. The method of claim 7 further comprising forming a seal between the packer wedge and the bore hole at the location beyond the first fracture.

9. A fracturing device comprising:
at least one nozzle with at least two ports;
a packer wedge coupled to the at least one nozzle; and
a location device operably coupled to and aligned with the at least one nozzle, the location device configured to determine a position and at least one orientation of the fracturing device when located in a bore hole, the location device further configured to transmit a sign indicating the position and orientation of the fracturing device to a remote device.

10. The fracturing device of claim 9 further comprising a leading segment section removably coupled between the nozzle and the packer wedge.

11. The fracturing device of claim 10 wherein the packing wedge is located between the locating device and the leading segment section.

12. The fracturing device of claim 10 wherein the locating device is located between the packer wedge and the nozzle.

13. The fracturing device of claim 10 wherein the packing wedge includes a conical portion adjacent the leading segment section and a semi-spherical portion adjacent the locating device.

14. The fracturing device of claim 10 wherein the nozzle is configured to fluidly couple with a fracturing system.

15. The fracturing device of claim 14 wherein the leading segment section has a diameter of 2.375 inches and a length of 10 feet.
